(19) United States
(12) Patent Application Publication
(10) Pub. No.: US 2002/0185282 A1
(43) Pub. Date: Dec. 12, 2002

(54) Fire suppression method and apparatus

(76) Inventor: Alan P. Kretschmer, Hales Corners, WI (US)

Correspondence Address: JOSEPH S. HEINO, ESQ., DAVIS & KUELTHAU, S.C., 111 E. KILBOURN, SUITE 1400, MILWAUKEE, WI, 53202-6613, US

(21) Appl. No.: 09/876,393

(22) Filed: Jun. 7, 2001

(51) Int. Cl. A62C 37/36

(52) U.S. Cl. 169/43; 169/16; 239/282; 239/208; 52/168

(57) ABSTRACT

A fire suppression method and apparatus has a wall bracket which is installable to one side of a wall. The wall bracket is configured with a plurality of openings such that multiple locations for the sprinkler head may be used and the precise installation of the sprinkler head within the wall can be accomplished with a wide variety of wall constructions and sprinkler heads. The wall bracket is attachable to support members, such as wall studs, within the wall and is laterally movable between them in a generally horizontal direction. A pair of wall clips are used to secure the wall bracket to the wall studs. A pipe clamp is provided which is insertable within the bracket to retain a pipe nipple within it. The pipe nipple is adjustable relative to the wall surface to move it inwardly and outwardly relative to the wall. In this fashion, the horizontal location of the sprinkler head can be adjusted depending upon the depth of the wall and the style of sprinkler head used. The pipe nipple is attached to a flexible armover connector which allows for an almost infinite number of locations that can be used to connect the pipe nipple to the supply line of the fire suppression system.

### FIELD OF THE INVENTION

This invention relates generally to devices and methods which may be used for the suppression of fires, including fire suppression systems which utilize one or more sprinkler heads, at least one of such sprinkler heads being attached to a fire suppression supply line by means of a flexible armover connection. More particularly, this invention relates to a method for installing a sprinkler head within a vertical wall, such sprinkler head being attached to a flexible armover connection, such that the sprinkler head is securely installed regardless of the location of the structural supports contained within the vertical wall. It also relates to an apparatus or assembly for allowing precise location and installation of the sprinkler head in an unlimited number of locations within that vertical wall relative to the structural wall supports. It also relates to an apparatus or assembly which allows for use of the apparatus or assembly with a wide variety of sprinkler head styles.

### BACKGROUND OF THE INVENTION

The use of water to suppress or extinguish fires is a concept as old as fire itself. And, quite probably as long as it has inhabited dwellings, mankind has long searched for the best way to effect the distribution of water within dwellings where the risk of death and destruction from fire is ever present. For many years, fire suppression systems which are installed in buildings have been comprised of a number of water supply lines installed above a suspended ceiling grid, the same type of grid which normally conceals other building utilities such as heating and cooling ducts, electrical supply lines and lighting fixtures, among other things. The water supply lines, in turn, are functionally adapted to supply water to sprinkler heads which are actuated by heat sensing means. This is, without question, old art.

In the experience and observations of the inventor of the present invention, the modem day suspended ceiling assembly typically consists of an array of standard sized acoustically dampening ceiling tiles. One reality of modem building design is that building owners and architects often specify that sprinkler heads be located on a “center of tile” basis. That is, the exact vertical centerline of the sprinkler head must protrude literally through the lengthwise and widthwise center of a given standard tile. The theory is that this “center of tile” appearance is more aesthetically pleasing and acceptable to the eye. In the experience of this inventor, the “center of tile” requirement always increases installation costs and causes great problems for the installers of the concealed fire suppression system. This inventor has addressed that problem with the method and apparatus disclosed in his U.S. Pat. No. 6,158,519 entitled “Fire Suppression Method and Apparatus.”

Another problem which arises in the installation of fire suppression systems within a building, and which can also increase installation costs, is that some sprinkler heads are required to be placed within a vertical wall, above or below the suspended ceiling. The problems attendant to this installation situation are somewhat similar to the center-of-tile ceiling installation described above. For example, location of the sprinkler head within the vertical wall may not coincide with the precise center between two adjacent wall supports, or wall studs. In order to deal with this problem, it is necessary to come up with some satisfactory way to locate and secure the sprinkler head at the desired location within the vertical wall.

### SUMMARY OF THE INVENTION

It is, therefore, a principal object of this invention to provide a new, useful and uncomplicated method and apparatus for effecting the locating of sprinkler heads within a vertical wall which requires only a minimal number of elements and which reduces installation costs. It is another object of this invention to provide such a method and apparatus for use within a wide variety of wall configurations and with a wide variety of commercially available sprinkler heads. It is yet another object of this invention to provide such a method and apparatus whereby the location of the sprinkler head can be accomplished in almost any position within such walls. It is still another object of the present invention to provide such a method and apparatus which requires only a minimum number of steps to use in the field. It is still another object of the present invention to provide such a method and apparatus which allows for prefabrication of standard parts which are readily usable in the field throughout a wide variety of installation situations and which requires a minimum of effort on the part of the user to install them. It is yet another object of the present invention to provide such a method and apparatus which allows for easy access to the joints of the assembly which are situated within the wall when such access is desired or required.

The present invention has obtained these objects. It provides for a fire suppression apparatus which has a sprinkler head support bracket which is installable to one side of a vertical wall. The support bracket is configured with a plurality of openings such that multiple locations for the sprinkler head may be used and the precise installation of the sprinkler head within the wall can be accomplished with a wide variety of wall constructions and sprinkler heads. The support bracket is attachable to support members, such as wall studs, within the wall and is laterally movable between them in a generally horizontal direction. A pipe clamp is provided which is insertable within the bracket to retain a pipe nipple within it. The pipe nipple is adjustable relative to the wall surface to move it inwardly and outwardly relative to the wall. In this fashion, the horizontal location of the sprinkler head can be adjusted depending upon the depth of the wall and the style of sprinkler head used. It is also understood that the device of the present invention could be installed in constructions which form a horizontal surface and still come within the scope of the present invention. In such installation, the vertical location of the sprinkler head could be adjusted depending upon the depth of the ceiling or floor and the style of sprinkler head used. The pipe nipple is attached to a flexible armover connector which allows for an almost infinite number of locations that can be used to connect the pipe nipple to the supply line of the fire suppression system. The foregoing and other features of the method and apparatus of the present invention will be further apparent from the detailed description which follows.

### BRIEF DESCRIPTION OF THE DRAWINGS

FIG. 1 is a front and left side perspective view showing a fire suppression assembly constructed in accordance with the present invention.

FIG. 2 is an enlarged front and left side perspective view of a fastening ring, or lock nut, portion of the fire suppression assembly shown in FIG. 1.

FIG. 2A is an enlarged front and left side perspective view of a fastening bracket, or wall clip, portion of the fire suppression assembly shown in FIG. 1.

FIG. 3 is an enlarged left side elevational view of the fire suppression assembly shown in FIG. 1.

FIG. 4 is an exploded top plan view of the fire suppression assembly shown in FIG. 3.

### DETAILED DESCRIPTION

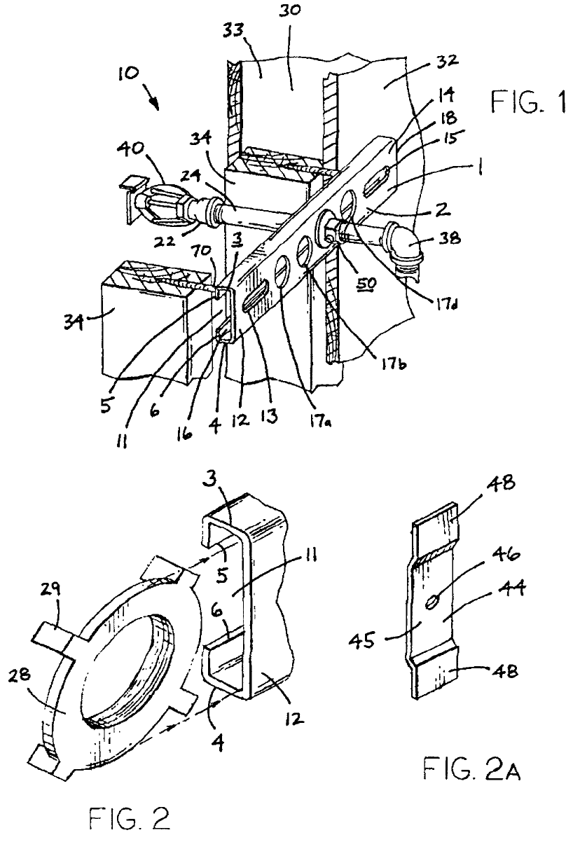

Referring now to the drawings in detail, FIG. 1 shows a fire suppression device constructed in accordance with the present invention. The preferred embodiment of the device includes a fire suppression assembly, generally identified 10, which includes a main wall bracket 1. The wall bracket 1 of the assembly 10 overlays a portion of a vertical wall 30. The wall 30 is typical in that it includes a plurality of vertically extending structural support studs 34 to each common vertical side of which are attached wall board pieces 32, 33, the wall board pieces 32, 33 being in parallel planar relationship to one another.

In the preferred embodiment, the wall bracket 1 is constructed of a single piece of sheet metal material. The wall bracket 1 includes a longitudinally extending central support portion 2 and a pair of inwardly extending leg portions 3, 4. The leg portions 3, 4 are integrally formed with the central support portion 2 and similarly run longitudinally with respect to it. Each leg portion 3, 4 lies in a plane which is generally perpendicular to the plane within which the central support portion 2 lies. The distal end of each leg portion 3, 4 includes an inwardly extending leg support portion 5, 6 each of which lies in a plane which is also generally perpendicular to the plane within which the leg portions 3, 4, respectively, lie. The leg portions 3, 4 are, however, generally parallel planar in relation to the central support portion 2. The longitudinally extending channel 11 which is defined, in part, by the central support portion 2, the leg portions 3, 4 and the leg support portions 5, 6, terminates at a first opening 16 at a first end 12 of the wall bracket 1 and a second opening 18 at the second end 14 of the wall bracket 1. Defined within the central support portion 2 are at least two longitudinally extending fastener openings 13, 15, each of which is generally slot-like in configuration. Also defined within the central support portion 2, and located on center with and between the fastener openings 13, 15, are a plurality of sprinkler mounting openings 17a, 17b, 17c, 17d.

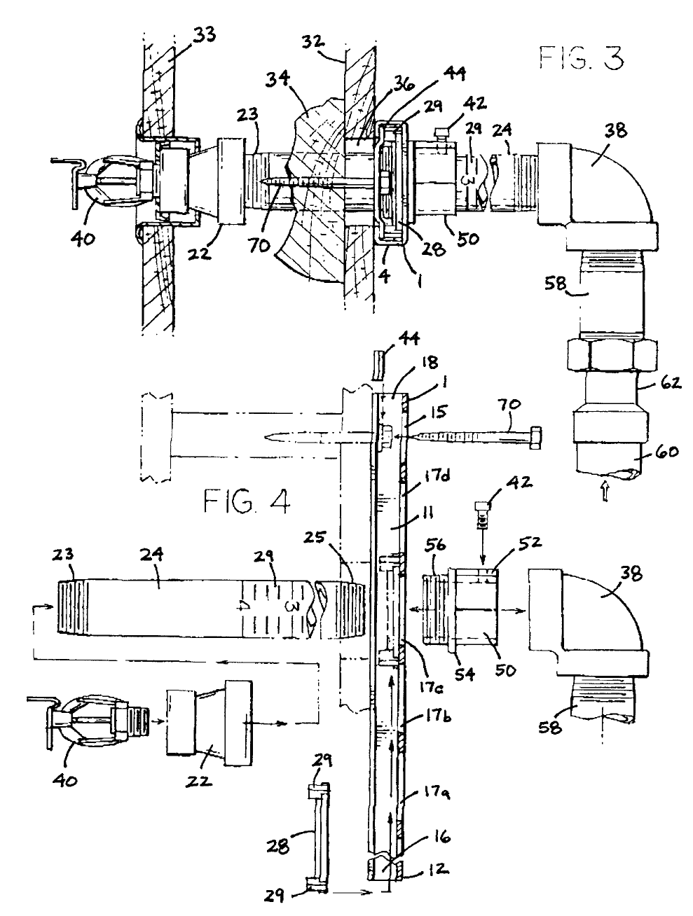

Referring now to FIGS. 3 and 4 in addition to FIG. 1, the fire suppression assembly 10 of the present invention also includes a concentric reducing coupling 22, a pipe nipple 24, a depth setting pipe clamp 50, and a 90° elbow 38. The concentric reducing coupling 22 essentially allows connection of the sprinkler head 40 to the first end 23 of the pipe nipple 24. The pipe nipple 24 is also threaded at its second end 25 such that it can also be attached to the 90° elbow 38. The elbow 38 could also assume other shapes and still come within the scope of the present invention. The purpose of the elbow 38 is to provide a connection to a flexible armover 60 and an adapter nipple 58. See FIG. 3.

The pipe nipple 24 is functionally adapted to be slidably received by the depth setting pipe clamp 50. The pipe nipple 24 also includes pipe markings 29, the function of which will be discussed later in this detailed description. The precise location of the pipe nipple 24 within the depth setting pipe clamp 50 can be fixed by virtue of a set screw 42 which is located within the hexagonal top portion 52 of the depth setting pipe clamp 50. Immediately below the hexagonal top portion 52 of the depth setting pipe clamp 50 is a shoulder and flange portion 54. The flange portion 54 is functionally adapted to rest upon and be supported by the outer surface of the central support portion 2 of the wall bracket 1. Extending below the shoulder portion 54 of the depth setting pipe clamp 50 is a threaded bottom portion 56. This threaded bottom portion 56 is functionally adapted to extend through any one of the holes 17a, 17b, 17c, 17d defined within the central support portion 2 of the wall bracket 1. The threaded bottom portion 56 allows the depth setting pipe clamp 50 to be removably secured to the wall bracket 1 by virtue of a fastening ring, or lock nut, 28. See FIG. 2. The lock nut 28 includes a plurality of nubs 29 which are equally spaced about the perimeter of the lock nut 28. Each nub 29 also extends beyond the perimeter of the lock nut 28. In the preferred embodiment of the device of the present invention, four such nubs 29 are provided. In this fashion, two of the nubs 29 are in proximity to one leg portion 3 of the wall bracket 1 and two of the nubs 29 are in proximity to the other leg portion 4. This construction prevents rotation of the lock nut 28 within the wall bracket channel 11 when the depth setting pipe clamp 50 is rotated within the hole 17a, 17b, 17c, 17d of the wall bracket 1.

In the preferred embodiment, the pipe nipple 24 has a series of depth-setting markings 29 defined along one side of the nipple 24 such that the location of the sprinkler head 40 can be precisely located relative to the wall 30, and the outer wall board 33 in particular. In the experience of the inventor, this feature allows the user to pre-set the depth of the pipe nipple 24 within the pipe clamp 50 while allowing for different wall constructions and various styles of sprinkler heads. More importantly, it allows the installer to accurately set the depth of the pipe nipple 24 without his or her need to view the opposite side of the wall 30 during installation. In this application, a horizontal type sprinkler head 40 would likely be used which would include a spray deflector to break up the pattern of spray and direct it outwardly and downwardly. The second end 25 of the pipe nipple 24 is attachable to a 90° elbow 38. The 90° elbow 38, in turn, is attachable to one end 62 of a flexible armover 60 by means of an adapter nipple 58. See FIG. 3. The other end (not shown) of the armover 60 is attachable to a branch line pipe (also not shown) situated to one side of the wall 30. In the preferred embodiment, the flexible armover 60 may be constructed of a number of commercially available flexible hoses including, but not limited to, metal, teflon, rubber, plastic or any combination of these materials. The important feature of the preferred embodiment is that the armover 60 be flexible and readily locatable relative to the main support bracket 1 without the need to disable the fire suppression system or alter any of its components.

The wall bracket 1 is held in place by virtue of a pair of fastener brackets, or wall clips, 44 which are functionally adapted to be slidably received within the channel of the wall bracket 1. See FIG. 2A. Each wall clip 44 includes a central clip body 45 defined within which is a single clip aperture 46. The clip aperture 46 is located in the physical center of the wall clip 44 and is functionally adapted to receive a fastener 70 through it. Extending outwardly from the central clip body 45 are a pair of clip flats 48, the clip 44 and clip flats 48 being symmetrical about the aperture 46. Each flat 48 is functionally adapted to engage and slide along the inner surface of the leg support portions 5, 6 of the wall bracket 1. While each wall clip 44 can slide along the entire length of the wall bracket channel 11, one wall clip 44 is intended to slide generally in the area of the first fastener opening 13 of the wall bracket 1 and the other wall clip 44 is intended to slide generally in the area of the second fastener opening 15. It is further intended that a fastener 70 be capable of passing through each slot-like fastener opening 13, 15 in order to secure each wall clip 44 to a wall stud 34 which lies directly behind it.

In application, the user of the method and apparatus of the present invention locates that portion of the vertical wall 30 at which installation of the sprinkler head 40 is to be accomplished. It is contemplated by the inventor that the individual components of the assembly 10 reach the installer in a somewhat preassembled condition, with the principal exception of the wall bracket 1, the wall clips 44, the wall fasteners 70, the lock nut 28, the armover 60 and the sprinkler head 40. The installer, knowing the size and depth of the wall 30 and also knowing the precise location and type of sprinkler head 40 which is to be installed, cuts a hole 36 through the wall 30 at the sprinkler head location. It is further assumed that the installer has located, by use of an electromagnetic stud locating device or other suitable method, the studs 34 which run vertically to either side of this installation location and hole 36. A horizontal line is then scribed through the center of the hole 36, extending the line to the studs 34 to either side of the hole 36. The pair of wall clips 44 are attached to the wall 30, one through to each stud 34 by means of a fastener 70. This attachment is made loosely to allow for some movement as the assembly 10 is positioned into place. A lock nut 28 is slid through an end opening 16, 18 of the support bracket 1 such that the lock nut 28 is slidably moveable along the bracket channel 11. As previously described, however, the lock nut 28 is only ever so slightly rotatable within the channel 11, only enough so as to allow easy placement of the lock nut 28 within the channel 11, the purpose of the nubs 29 of the lock nut 28 being to prevent rotation of the lock nut 28 within the channel 11. The wall bracket 1 is then lifted into place and one end opening 18 of the bracket 1 is slid over a first wall clip 44 sufficiently to then allow the second wall clip 44 to engage the opposing end opening 16 of the bracket 1 as the bracket 1 is urged against the wall 30. The wall bracket 1 is then slid into position such that the best positioned sprinkler mounting opening 17a, 17b, 17c, 17d overlays the hole 36 which has been cut into the wall 30. Depending upon the location of the hole 36 relative to the studs 34, one of the mounting openings 17a, 17b, 17c, 17d may be used in any given application. This allows the hole 36 to be positioned anywhere between the two studs 34. The fasteners 70 are then accessed by means of the fastener openings 13, 15 defined within the bracket 1 and tightened sufficiently to secure the wall clips 44 and the wall bracket 1 to the wall 30. By this action, the flats 48 of each wall clip 44 engage the leg support portions 5, 6 of the wall bracket 1. The lock nut 28 is then slid along the channel 11 such that it too is aligned with the hole 36 which has been cut into the wall 30. The pipe nipple 24 and the pipe clamp 50 assembly are slid through the bracket 1, the lock nut 28 and the wall 30 until the threads 56 of the pipe clamp 50 come into contact with the lock nut 28. The pipe clamp 50 is secured to the bracket 1 by mechanical rotation of the hexagonal portion 52 of the pipe clamp 50. The flexible armover 60 is attached to the adapter nipple 58. Proper positioning of the pipe nipple 24 is accomplished by utilizing the pre-printed markings 29 on the pipe nipple 24. Once the depth of the pipe nipple 24 is properly set and the assembly 10 is properly positioned, the set screw 42 of the pipe clamp 50 is tightened. This prevents further movement of the pipe nipple 24 within the pipe clamp 50. The sprinkler head 40 is then installed at the reducing coupling 22 which is located at the opposite end of the pipe nipple 24. It should also be noted here that the sprinkler head 40 may be installed prior to installing the pipe nipple 24 and its related assembly into the wall bracket 1. It should also be noted here that, once the assembly 10 is charged with fluid, any leak which may be detected by the installer at the point of the joint which is created between the sprinkler head 40 and the reducing coupling 22 or at the joint which is created between the reducing coupling 22 and the pipe nipple 24 may be easily dealt with. The installer simply loosens the set screw 42 of the pipe clamp 50, urges the assembly out from the wall 30 and repairs the leaking joint. Using the preprinted markings 29 on the pipe nipple 24, the precise re-location of the assembly 10 within the wall 30 is accomplished.

From the foregoing, it will be apparent that there has been provided a new, useful and uncomplicated method and apparatus for effecting the locating of sprinkler heads within a vertical wall which method and apparatus requires only a minimal number of elements; which reduces installation costs; which can be used within a wide variety of wall configurations and with a wide variety of commercially available sprinkler heads; which allows for the location of a sprinkler head in almost any position within such walls; which requires only a minimum number of steps to use in the field; which are readily usable in the field throughout a wide variety of installation situations; which requires a minimum of effort on the part of the user to install them; and which allows for easy access to the joints of the assembly which are situated within the wall when such access is desired or required.

The principles of this invention having been fully explained in connection with the foregoing, I hereby claim as my invention:

1. For use in a fire suppression system, said system being located at a wall and having at least one fixed fluid supply line and at least one sprinkler head for dispersing fluid to one side of said wall, an apparatus for locating a sprinkler head within the wall which comprises
means for locating a sprinkler head at a point within the wall,
means for adjustably setting the depth of the sprinkler head relative to said wall, and
a flexible hose connecting the sprinkler head to said fixed fluid supply line.

2. The sprinkler head locating apparatus of claim 1 wherein said sprinkler head locating means comprises a sprinkler head support bracket which is functionally adapted to overlay adjacent support members within the wall and to be supported by two support bracket clips.

3. The sprinkler head locating apparatus of claim 2 wherein said sprinkler head support bracket includes a plurality of support holes defined within said bracket.

4. The sprinkler head locating apparatus of claim 3 wherein said depth setting means includes a pipe nipple connected to said sprinkler head and further includes a pipe nipple pipe clamp which is functionally adapted to be supported within any one of the support holes defined within said sprinkler head support bracket, said pipe nipple being movable within said pipe nipple pipe clamp whereby the position of the sprinkler head may be variably adjusted relative to the wall.

5. The sprinkler head locating apparatus of claim 4 wherein said flexible hose comprises a metallic hose with a braided metallic sleeve.

6. The sprinkler head locating apparatus of claim 5 wherein said flexible hose comprises a rubber hose.

7. A method for locating sprinkler heads used in a fire suppression system, said system being located at a wall and having at least one fixed fluid supply line and at least one sprinkler head for dispersing fluid to one side of said wall, which comprises the steps of
providing a means for locating a sprinkler head at a point within the wall,
providing means for adjustably setting the depth of the sprinkler head relative to said wall, and
providing a flexible hose for connecting the sprinkler head to said fixed fluid supply line.

8. The method of claim 7 wherein said sprinkler head locating step comprises providing a sprinkler head support bracket which is functionally adapted to overlay adjacent support members within the wall, said support bracket having a plurality of support holes defined within said bracket which correspond to the point within the wall at which the sprinkler head is located.

9. The method of claim 8 wherein said depth setting means providing step includes providing a pipe nipple and connecting said pipe nipple to said sprinkler head and further includes providing a pipe nipple pipe clamp, said pipe nipple pipe clamp being functionally adapted to be supported within any one of the support holes defined within said sprinkler head bracket, said pipe nipple being movable within said pipe nipple pipe clamp whereby the position of the sprinkler head may be variably adjusted relative to the wall.

10. The method of claim 9 wherein said hose providing step includes providing a metallic hose with a braided metallic sleeve.

11. The method of claim 10 wherein said hose providing step includes providing a rubber hose.
